(19) United States
(12) Patent Application Publication
(10) Pub. No.: US 2019/0287045 A1
(43) Pub. Date: Sep. 19, 2019

(54) SYSTEM FOR LOAD BALANCING USING DYNAMIC DEVIATION OF ACCEPTABLE LOAD

(71) Applicant: Continental Casualty Company, Chicago, IL (US)

(72) Inventors: Paul J. EDWARDS, Wheaton, IL (US); Robert M. THOMAS, II, Higganum, CT (US)

(73) Assignee: Continental Casualty Company, Chicago, IL (US)

(21) Appl. No.: 16/004,203

(22) Filed: Jun. 8, 2018

Related U.S. Application Data
(60) Provisional application No. 62/644,466, filed on Mar. 17, 2018.

(51) Int. Cl. G06Q 10/06; G06Q 40/08

(52) U.S. Cl. CPC G06Q 10/063116; G06Q 40/08

(57) ABSTRACT

A method for load balancing using a dynamic allowed deviation. The method includes identifying tasks to be assigned to workers and identifying a first set of attributes for each task. The method further includes the step of identifying a second set of attributes for each worker. The allowed deviation between the highest number of tasks assigned to a worker and the lowest number of tasks assigned to a worker based on the number of tasks being assigned during a predetermined time period is computed. Each of the plurality of tasks is assigned to a worker based on matching at the first set of attributes with the second set of attributes. The assigning of the tasks is conducted so that the difference between the highest number of tasks assigned to a worker and the lowest number of tasks assigned to a worker does not exceed the allowed deviation.

### CROSS REFERENCE TO RELATED APPLICATIONS

This application claims priority to and the benefit of U.S. Provisional Patent Application No. 62/644,466 filed Mar. 17, 2018. The foregoing provisional application is incorporated by reference herein in its entirety.

### BACKGROUND

The present disclosure relates to systems and methods for distributing and assigning tasks to workers in a balanced manner (i.e., load balancing).

An insurance company is one example of a business entity that could benefit from a load balancing system and method. Insurance companies rely on the ability to sort through incoming insurance claims in a quick and efficient manner to best serve their clients. Traditional work assignment methods ensure that insurance claims are assigned to a handler, but often not efficiently. These traditional assignment methods often create a backlog of work and lead to inefficient and wasteful use of company resources.

Existing insurance claim assignment systems may factor in some limited information regarding attributes of particular case handlers in order to attempt to match particular type of claims with claim handlers possessing certain general attributes for handling those types of claims. Such a system of matching an insurance claim of a given type to a claim handler with a given general attribute appears to ensure that a qualified person is assigned to the claim, but this sort of traditional filtering and assignment system does not account for special insurance claims that may require a claim handler that possesses one or more specific attributes.

In addition, existing claim assignment systems do not provide for segmenting incoming insurance claims by both class and priority. Existing systems only provide for one dimensional prioritization (i.e., insurance claims are escalated to the highest possible point based on either class and priority) and these systems require user intervention or the specific entry of hard-coded overrides or exception rules to move an insurance claim to a lower position in the hierarchy.

### SUMMARY

The present application discloses an embodiment of a computer implemented method for load balancing using a dynamic allowed deviation. The method includes several steps including identifying a plurality of tasks to be assigned to a plurality of workers and identifying a first set of attributes for each of the tasks. The method further includes identifying a second set of attributes for each of the plurality of workers, wherein one of the attributes in the second set of attributes is the number of tasks being handled by the worker. When carrying out the method an allowed deviation between the highest number of tasks assigned to one of the plurality of workers and the lowest number of tasks assigned to one of the plurality of workers based on the number of the plurality of tasks being assigned during a predetermined time period is computed. The method includes assigning each of the plurality of tasks to one of the plurality of workers based on matching at least a portion of the first set of attributes with at least a portion of the second set of attributes and wherein the assigning of the tasks is conducted so that the difference between the highest number of tasks assigned to one of the plurality of workers and the lowest number of tasks assigned to a worker does not exceed the allowed deviation.

In another exemplary embodiment, an insurance claim processing system is disclosed. The system includes a processor configured to receive a first set of attributes related to an insurance claim. The processor is configured to receive a plurality of second set attributes, wherein each of the attributes in the second set of attributes is associated with a particular claim handler. One of the attributes in the second set of attributes is the number of insurance claims being handled by the associated claim handler, and wherein the processor is configured to assign the insurance claim to one of a plurality of claim handlers so that the difference between the highest number of claims assigned to each of the plurality of claim handlers and the lowest number of claims assigned to a claim handler does not exceed an allowed deviation. The processor is configured to determine the allowed deviation based on the number of claims assigned to the claim handlers over a predetermined period of time.

In another exemplary embodiment, an alternative insurance claim processing system is disclosed. The system includes a processor configured to receive a first set of attributes related to an insurance claim. The processor is configured to receive a plurality of second set attributes, wherein each of the attributes in the second set of attributes is associated with a particular claim handler. At least one of the plurality of second sets of attributes includes a conditional attribute, and wherein the conditional attribute includes at least two attributes associated with the claim handler. The processor is configured to designate the insurance claim as being handled by the claim handler when the attributes in the first set of attributes are matched in the second set of attributes, and wherein the processor is configured so that the at least two attributes that make up the conditional attribute are only available to be matched with the first set of attributes when all of the at least two attributes are present in the second set of attributes.

It is to be understood that both the foregoing general description and the following detailed description are exemplary and explanatory only, and are not restrictive of the invention as claimed.

### BRIEF DESCRIPTION OF THE DRAWINGS

Features, aspects, and advantages of the present disclosure will become apparent from the following description, appended claims, and the accompanying exemplary embodiments shown in the drawings, which are briefly described below.

FIG. 1 depicts a graphical representation of a system to implement a method of intelligent load balancing according to one or more embodiments;

FIG. 2 depicts a process for intelligent load balancing according to one or more embodiments;

FIG. 3 depicts a graphical representation of a system to use conditional attributes to assign insurance claims according to one or more embodiments;

FIG. 4 depicts a process for using conditional attributes to assign insurance claims according to one or more embodiments;

FIG. 5 depicts a graphical representation of a system to implement a Bidirectional Hierarchy Segmentation Model according to one or more embodiments;

FIG. 6 depicts a process for using a Bidirectional Hierarchy Segmentation Model to assign insurance claims according to one or more embodiments; and

FIG. 7 depicts a device designed to implement the processes described in FIG. 2, FIG. 4, and FIG. 6, according to one or more embodiments.

FIG. 8 depicts a system for processing worker tasks such as, for example, insurance claims.

### DETAILED DESCRIPTION

Disclosed herein are improved systems and methods for distributing and assigning tasks or assignments. These systems and methods provide variable load balancing amongst users, variable attribute matching, and bilateral hierarchy segmentation of claims. For example, one disclosed embodiment is directed to a method for intelligent load balancing including distributing and assigning new insurance claims and insurance claims being reassigned to claim handlers in a relatively even manner over a short period of time (e.g., 24 hours) while making incremental progress toward balancing the loading of claims amongst peer groups of claim handlers over time. This method includes a dynamic “allowed deviation” applied to a predetermined short period of time that works in tandem with traditional load balancing methods for distributing and assigning tasks (with assignment priority given to the lowest actual or weighted user workload at any given point in time). As described herein, the improved system and method may be implemented for handling load balancing and segmentation in the processing of insurance claims, for example.

One embodiment is directed to a method for establishing eligible claim handlers at any given point in time for new assignments and reassignments using sophisticated user profiles comprised of both traditional attributes and “conditional attributes”. Each insurance claim has predefined attributes, all of which are required to be on a claim handler's profile for that claim handler to be eligible for receiving an assignment. Traditional attributes are applied universally. So, for example, if any attribute of the insurance claim required to determine assignment eligibility does not exist on a particular claim handler's profile, that particular claim handler would not be eligible for assignment of that insurance claim under any condition. A conditional attribute may be defined as combination of two (2) or more existing attributes. When used herein the term “attribute” may be considered to be an item of data and may be arranged, stored and communicated in a format for processing by a computer processor. Thus, attributes associated with a task (e.g., insurance claim) may be arranged, stored and communicated in a first data set or file and the attributes associated with a worker (e.g., an insurance claim handler) may be arranged, stored and communicated in a second data set or file.

A claim handler is only recognized as having the attributes that make up the conditional attribute when all the attributes that make up the conditional attribute that are required for the insurance claim being assigned or reassigned are present. Conditional attributes are not applied universally, but instead only when the condition defined by the conditional attribute exists. The limited application of the conditional attributes allows for user profiles to be maximized without adding complexity to the assignment and distribution process.

Another disclosed embodiment is directed to a method for configuring segmentation and business rules to establish an insurance claim in a segment at first notice of loss (FNOL) and/or at other stages of the process of handling the claim. This method of configuring the rules includes the following improvements: the use of a simple algorithm that powers the business rules engine; the utilization of various predictive model outputs; the ability to configure the segmentation hierarchy via the method of configuring the rules; and provides full transparency regarding the rules that determine the segmentation of an insurance claim. This method also allows the system administrator to write both override and exception rules that drive the segmentation of the claim down the segmentation hierarchy and escalation rules that drive the segmentation of the claim up the segmentation hierarchy.

This method may include the following steps: (a) If any override rules are true, distribute a claim to the lowest segment in the hierarchy of those override rules that are true. (b) Else, if any escalation rules are true, distribute the claim to the highest segment in the hierarchy of those escalation rules that are true. (c) Else, distribute the claim to default segment.

Optionally, the above embodiments may be implemented via micro services external to a main claim processing system. Such services could be utilized both by applications internal to the claim servicer and by third parties with permission. These micro services may function to provide the following: leverage cloud computing to be both scalable and highly available; publish RESTful APIs that will leverage JSON frameworks to be leveraged by other systems during the lifecycle of the claim; call external APIs to capture additional data required for segmentation, such as claim severity and claim fraud models; leverage a rules engine that enables the business users to update on demand; and leverage user attribute data.

The model and load balancing micro services may be called upon when a claim is first reported and periodically during the claim lifecycle when the attributes of a claim, the business rules or staffing models change.

One aspect of the disclosed embodiments of the system and method is directed to organizing and assigning insurance claims using intelligent load balancing, conditional attributes, and bidirectional hierarchy segmentation. Various disclosed embodiments are directed to systems, methods, and devices for the collection, processing and assignment of a set of insurance claims to a plurality of users (i.e., claim handlers), where each of the users have a profile. However, it should be appreciated that processes and device configurations discussed herein may be applied to other methods of collecting, processing and assigning insurance claims.

References throughout this document to “one embodiment,” “certain embodiments,” “an embodiment,” or similar terms mean that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics disclosed herein may be combined in any suitable manner in one or more embodiments without limitation. For example, two or more of the innovative methods described herein may be combined in a single method, but the application is not limited to the specific exemplary combinations of improvements to claim assignment and distribution that are described herein.

The term “load balancing” refers hereinafter to the process of distributing tasks across multiple workers (e.g., distributing insurance claims across multiple users or claim handlers) in a fashion that optimizes distribution based on factors including but not limited to providing the fastest response time, using a worker's time as efficiently as possible, and ensuring that no single worker is overburdened with tasks.

The term “allowed deviation” refers hereinafter to the difference between the user with the highest and lowest number of new task assignments or a combination of new task assignments and task reassignments over a pre-determined period of time (e.g., typically a short period of time).

The term “dynamic allowed deviation” refers hereinafter to an allowed deviation that changes dynamically in proportion to the number of task assignments distributed to the peer group of users over the predetermined short period of time. A dynamic allowed deviation is an effective alternative to a static allowed deviation and allows the method to be applied seamlessly to peer groups or users with the volumes of assigned tasks ranging from very low to very high. A static allowed deviation is an improvement over existing models as well. This type of deviation supports normal worker load balancing as well as distributing tasks during a required ramp up period for new workers or workers returning from vacation, for example.

The term “attribute” refers hereinafter to a code, tag, word or symbol assigned to a user or worker profile, wherein the attribute is indicative of or describes a skillset or trait of that user which may be relevant to the assignment of a task (e.g., an insurance claim). The attribute may be embodied as, for example, a metatag.

The term “peer” refers hereinafter to a group of workers (e.g., claim handlers) with similar attributes.

The term “segment” refers hereinafter to an attribute of a task (e.g., an insurance claim) used to determine the level (e.g., the priority level) or type of user required to handle that particular task. Segmentation also plays a critical role in grouping like users (peers), which is foundational for successfully distributing tasks (e.g., insurance claims) in a relatively even manner and load balancing over time (i.e., a group of peers is required to create relative balance amongst the users assigned to the peer group).

The character “n” refers hereinafter to the last member of a set or the total count of members in a set.

The character “x” refers hereinafter to a variable member of a set.

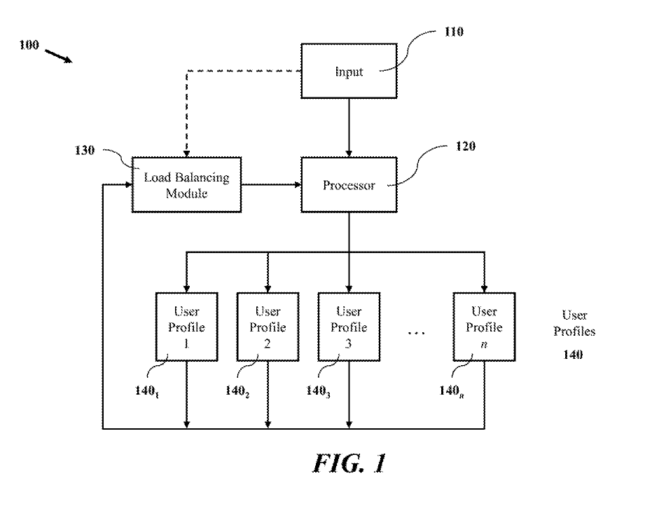

FIG. 1 depicts a graphical representation of a system to implement a method of intelligent balancing of claim loading on users according to one or more embodiments. The system (which may be resident on a computer network including standard hardware such as, for example, servers, monitors, user interface devices, etc.) may include an input 110 that collects data regarding insurance claim(s). The input 110 may be a device that receives data, carries data and/or that processes data—for example, prior to the data being provided to the processor. This data may be from newly received insurance claims, previously assigned insurance claims, or a combination of both new and previously assigned claims. The data managed and processed by the input 110 may be provided to the system in a number of ways—for example, by receiving an electronic file containing information about the claim from any number of sources including (but not exclusive to) a team leader, an agent, a medical service provider, or a data storage unit. According to some embodiments, incoming telephone calls and/or documents may be used to create information in a claim system which, in turn, can be provided (e.g., via the input) to the insurance claim processing system. In other embodiments, the insurance claim processing system may utilize an input device to retrieve information from a data warehouse. In other embodiments, some or all of the information about an insurance claim may be received via a claim submission process from the policy holder.

Input 110 may send the data to a processor 120 as the data comes in once the data is all collected or as a plurality of packets. Once the processor 120 has received the data, the processor applies a set of rules provided by a load balancing module 130 to the data in order to decide how to assign the new insurance claim data to a user, wherein each user has a user profile 140.

In one embodiment, the system 100 may use its user profile 140₁₋ₙ data to periodically or intermittently update a load balancing module 130 with new rules. This data may include a user's current workload, a user's temporary leave status, or other criteria relevant to the task of balancing the loading of claims amongst multiple users. In one embodiment, the system 100 uses its user profile 140₁₋ₙ data to calculate the dynamic allowed deviation for a given time period and then uses that value to update the load balancing module 130.

In another embodiment, the input 110 may also collect new rules to update the rules stored in the load balancing module 130. The updated rules may be based on data collected from the input 110, its user profiles 140_{1 -n} and the current workload of the users, or any special conditions the system administrator deems necessary.

The system 100 may use actual or weighted user claims loading (e.g., caseload) when determining assignment priority for load balancing. In one embodiment, the factors that contribute to a weighted evaluation may change depending on the user's needs.

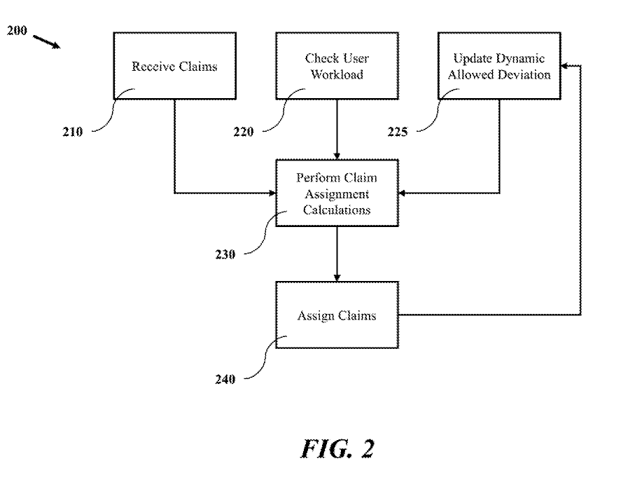

FIG. 2 depicts a process for intelligent load balancing according to one or more embodiments. The load balancing process 200 may be performed by a generic computing device or specialized hardware optimized for the process. The load balancing process 200 may be initiated at step 210 by receiving one or more insurance claims. These insurance claims may be new insurance claims, previously assigned insurance claims, or a combination of the two. Once the claims are received (i.e., step 210 is complete), the next step 220 includes performing a check of the current user workload in order to perform load balancing properly. Then, the process 200 includes the step 230 of performing insurance claim assignment calculations using the received insurance claim data, current user workload and dynamic allowed deviation.

The insurance claim assignment calculations step 230 may include a method of assigning insurance claims using the timestamp of assignments. Given a set of users wherein each user has a timestamp associated with his or her last assignment, this method will assign the next insurance claim to the user with the least recent assignment timestamp. The advantages of this method include even distribution of insurance claims among users in the short-term. This method may lead to unbalanced caseloads over time and may be utilized without the capability to weight individual insurance claims. Thus, the system includes a provision for utilizing the timestamp method of assignment in situations where outside input has been provided by a system administrator or when the rules require the timestamp method to be used due to various data inputs received that indicate that such a method of distribution and assignment is appropriate.

The insurance claim assignment calculations step performed in the insurance claim assignment calculations step 230 includes a method of assigning insurance claims using the total count of assignments over a given period. Given a set of users wherein each user has a total assignment count over the given period, this method will assign the next insurance claim to the user with the lowest count of assignments over the given period. The advantages of this method include even distribution of insurance claims among users in the short-term and the ability to weight individual insurance claims (e.g., a particularly difficult insurance claim may count as multiple assignments when tallying assignment count). This count based claim assignment method may lead to unbalanced caseloads over time and may be utilized without the capability to intelligently reduce assigned claims for select users for specified periods of time without creating an undesired “catch up” scenario when the given time period ends (with potential imbalances increases as the given period becomes longer).

The insurance claim assignment calculations step 230 may include a method of assigning insurance claims using caseloads as a factor. Any given assignment may have a weight associated with it representing the “load” of that insurance claim (i.e., how many of the user's resources it will take in order to complete the assignment). Given a set of users with differing caseloads, this method will assign the next insurance claim to the user with the lowest current caseload. The advantages of this method include balanced caseloads over time, the ability to discount caseloads, and the ability to weight individual insurance claims (for weighting caseloads). The disadvantages of this method include uneven distribution of insurance claims among users in the short-term.

The process 200 may include the step 240 of assigning insurance claims to the plurality of user profiles. This step includes updating each user profile with one or more new insurance claim assignments and either sending the new insurance claim assignments to the user's personal workstation or allowing the user to access the new insurance claim assignment on a server device.

Once the step 240 of assigning insurance claims to the plurality of user profiles is completed, the process 200 undergoes the next step 225 of using the current user profile caseloads to update the dynamic allowed deviation. In particular, the updating step 225 including calculating the dynamic allowed deviation using the difference between the caseload of the most burdened user and the caseload of the least burdened user. In one embodiment, process 200 may also set an initial allowed deviation value during the updating step 225.

In one embodiment, the process 200 may repeat itself as many times as necessary in order to achieve an optimum load balancing condition.

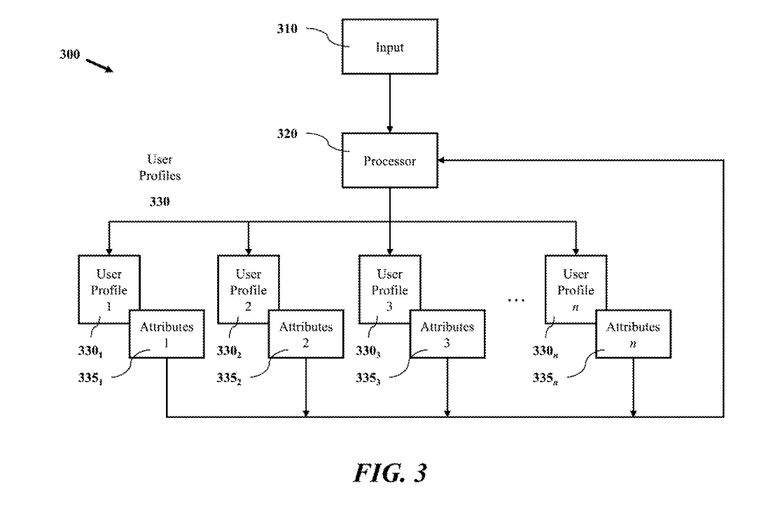

FIG. 3 depicts a graphical representation of a system to use conditional attributes to assign insurance claims according to one or more embodiments. The system may include an input 310 that collects insurance claim data. This data may be from newly received insurance claims, previously assigned insurance claims, or a combination of the two. The input 310 may send the data to a processor 320 as the data comes in once the data is all collected or as a plurality of packets. Once the processor 320 has the data, it checks the collected insurance claim data to determine how to build a conditional attribute or conditional attributes. It then polls the user profiles 330₁₋ₙ for their attributes 335₁₋ₙ and matches those attributes against the constructed conditional attribute or conditional attributes. A user is only recognized as having the attributes that make up the conditional attribute when all the attributes that make up the conditional attribute are required for the insurance claim being assigned or reassigned. Once a match is found, the processor 320 assigns insurance claims to a user profile 330, based on matching attributes.

In one embodiment, users designated or dedicated to a particular account are listed in the account's special claim handling instructions, which are found in an account profile instead of a user profile 330ₓ. Information about designated or dedicated users may be contained in account profiles separate from user profiles. In this instance, determining a user or handler's eligibility includes a separate step of looking up the account's special claim handling instructions prior to and separate from determining eligibility using the aforementioned attributes and handler profiles.

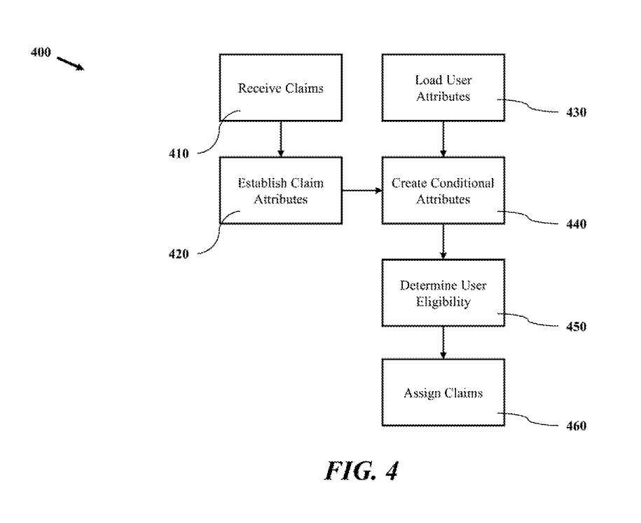

FIG. 4 depicts a process 400 for using conditional attributes to assign insurance claims according to one or more embodiments. The process 400 may be performed by a generic computing device or specialized hardware optimized for the process.

In order to determine a list of eligible users for purposes of insurance claim assignment, the process 400 may include the step 420 of establishing the attributes associated with an insurance claim. The process 420 is based on the system having been provided information (or determining independently) regarding which attributes are required to determine assignment eligibility and which users have those required attributes at any given point in time. In order to determine which users have the required attributes, traditional assignment solutions utilize user profiles, which contain details about users including assignment attributes amongst other things. Examples of traditional attributes related to the claim handler include the insurance claim segment (i.e., high, medium, low, etc.), jurisdiction state, region (groups of states, zip codes, etc.), account numbers (for designated/dedicated handling), catastrophe codes and other areas of expertise (e.g., speaks Spanish, handles employee insurance claims, etc.). It is also important to note traditional attributes are applied universally—meaning, if any attribute of the insurance claim required to determine assignment eligibility does not exist on a particular user's profile, that particular user would not be eligible for assignment of that insurance claim under any condition.

The process 400 may be initiated with a step 410 of receiving one or more insurance claims. These insurance claims may be new insurance claims, previously assigned insurance claims, or a combination of the two. The data regarding the claims may be received in a number of ways—for example, by receiving an electronic file containing information about the claim from any number of sources including (but not exclusive to) a team leader, an agent, a medical service provider, or a data storage unit. According to some embodiments, incoming telephone calls and/or documents may be used to create information in a claim system which, in turn, can be provided (e.g., via the input) to the insurance claim processing system. In other embodiments, some or all of the information about an insurance claim may be received via a claim submission process from the policy holder. When examining a single insurance claim, the process 400 then uses the insurance claim data to accomplish the step 420 of establishing the insurance claim attributes. Once the step 420 of establishing the attributes is complete, the process includes the step 430 of loading each user's attributes from their user profile. The next step 440 includes creating one or more conditional attributes based on the requirements of the received insurance claims. The step 440 also includes checking the insurance claim needs against the conditional attributes of each user in order to find qualified users and undergo the final step 450 of assigning the appropriate insurance claims to those users.

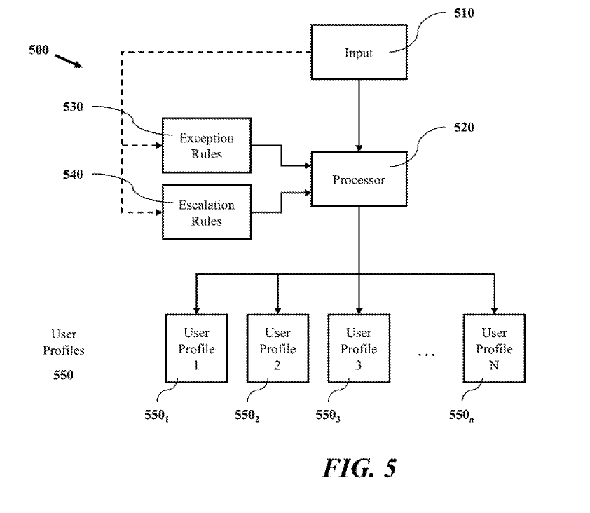

FIG. 5 depicts a graphical representation of a system to implement a Bidirectional Hierarchy Segmentation Model according to one or more embodiments. The system may include an input 510 that collects insurance claim data. This data may be from newly received insurance claims, previously assigned insurance claims, or a combination of the two. The input 510 may send the data to a processor 520 as the data comes in once the data is all collected or as a plurality of packets. Once the processor 520 has the data, it checks the collected insurance claim data against the stored exception rules 530 and escalation rules 540. In one embodiment, the processor 520 performs the rules check in the order of exception rules 530 first, then escalation rules 540 second, and standard hierarchical segmentation third. The processor 520 then segments the insurance claim data based on these various criteria. Once a given insurance claim has been segmented, the processor 520 applies load balancing rules (e.g. the load balancing rules 130 in FIG. 1) to the data in order to decide how to assign the new insurance claim data among the user profiles 550.

The data collected by the input 510 may include updates to the exception rules 530 and escalation rules 540. Traditional escalation models are unidirectional (i.e., escalate [up] to the desired segment when a particular rule is true) and inevitably require hard-coded override (or exception) rules. The algorithm that powers the Bidirectional Hierarchy Segmentation Model implemented in the system 500 allows the business to configure two (2) types of rules (escalation and override) and, as such, is bidirectional in nature eliminating the need to hard-code exception rules.

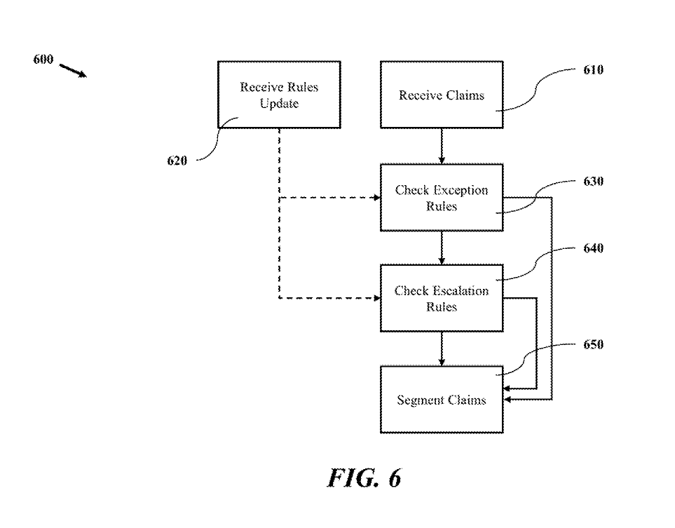

FIG. 6 depicts a process for using a Bidirectional Hierarchy Segmentation Model to assign insurance claims according to one or more embodiments. The process 600 may be performed by a generic computing device or specialized hardware optimized for the process.

The process 600 may be initiated by the step 610 of receiving one or more insurance claims. As described above, the claims may be new insurance claims, previously assigned insurance claims, or a combination of the two. The data regarding the claims may be received in a number of ways—for example, by receiving an electronic tile containing information about the claim from any number of sources including (but not exclusive to) a team leader, an agent, a medical service provider, or a data storage unit. According to some embodiments, incoming telephone calls and/or documents may be used to create information in a claim system which, in turn, can be provided (e.g., via the input) to the insurance claim processing system.

In other embodiments, some or all of the information about an insurance claim may be received via a claim submission process from the policy holder. Once the data regarding the claims is received, the process includes the step 630 of checking each insurance claim to see if it meets the conditions set by the exception rules. If an insurance claim matches an exception rule, the insurance claim the process includes the step 650 of segmenting the claim based on the exception rule. The remaining claims are checked at the escalation checking step 640 to determine if the claims meet the conditions set by the escalation rules. If an insurance claim matches an escalation rule, the insurance claim undergoes the segmenting step 650 based on the escalation rule. Then, claims not matched in the checking steps 630, 640 are segmented via the segmenting step 650 using standard segmentation rules.

In one embodiment, the segmenting step 650 uses a scoring model, where the model includes weighing various attributes of a claim to determine a score, typically between 0 and 100, and where segmentation is determined based on predetermined ranges or thresholds (e.g., a claim with a score of 89 may be segmented to the High segment, where a High claim must have a score of 80 or more).

In one embodiment, the segmenting step 650 uses a rules-based algorithmic model, in which the order of business rules are utilized. The rules are executed in sequential order until a claim segment is found, at which point the system discontinues searching for a claim segment.

In another embodiment, the segmenting step 650 uses a rules-based escalation model, where the order of business rules are not considered or utilized. All rules are executed and return a segment; the claim is segmented to the highest segment of any rules that are true or defaults to the lowest segment if no rules are true.

In yet another embodiment, the segmenting step 650 uses a segmentation rules engine, which may function as a variation of a rules-based model where the rules may be configured by the business.

The Bidirectional Hierarchy Segmentation Model provides for the use of various outputs of predictive models in more creative ways than traditional escalation models allow. For example, if the predicted severity of an insurance claim at time of assignment is less than some predetermined amount, the Bidirectional Hierarchy Segmentation Model allows the business to override other escalation rules to drive the insurance claim to a lower segment (as per the exception checking step 630). If the insurance claim attributes change over time, the segmentation model will repeat process 600 with respect to the updated insurance claim, thus seamlessly reassigning the insurance claim to a new segment (either a higher or lower segment). With traditional escalation models, the hierarchy itself is predetermined and static. Another feature of Bidirectional Hierarchy Segmentation Model is that the model enables system administrators to add, edit, delete, set default segment and/or prioritize segments within the hierarchy dynamically, which increases the longevity of the solution as it may be reconfigured (or evolve) as the business evolves with little to no additional investment required.

As shown in FIG. 6, this is represented by the process receiving, in step 620, a rules update, and then updating the conditions used by steps of checking the exception rules 630 and the escalation rules 640 to flag insurance claim assignments with exceptions or escalations. The solution design of the Bidirectional Hierarchy Segmentation Model also provides full transparency regarding the rules that determine the insurance claim segment. In one embodiment, the step 620 of receiving the rules update may also include conveying the addition of a new segment to the segmentation hierarchy in addition to conveying a rules change.

In one embodiment, the process 600 may also utilize various outputs of existing and future predictive models in order to dynamically alter the exception and escalation rules in the checking steps 630, 640. For example, if the predicted severity of an insurance claim at time of assignment is less than some predetermined amount, the Bidirectional Hierarchy Segmentation Model allows the business to override other escalation rules to drive the insurance claim to a lower segment. If the insurance claim attributes change over time, the segmentation model will seamlessly reassign the insurance claim to a new segment, to either a higher or lower segment.

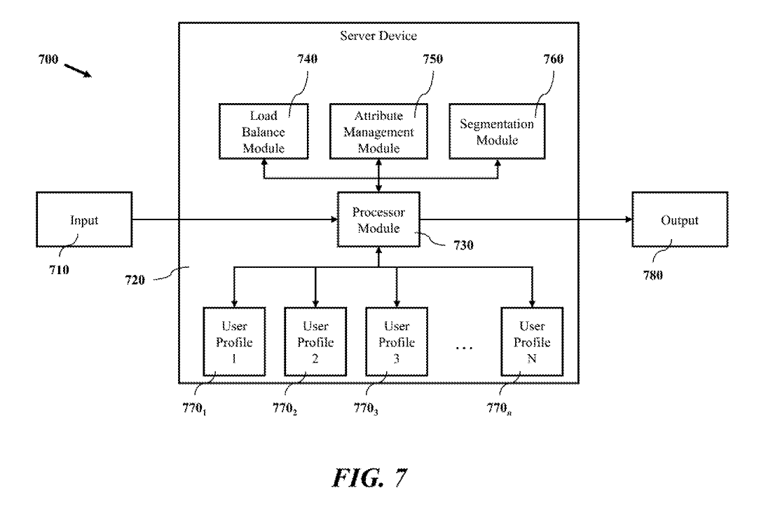

FIG. 7 depicts a system or device designed to implement the processes described above, for example, in FIG. 2, FIG. 4, and FIG. 6, according to one or more embodiments. The system or device 700 may be configured to accept new or recurring insurance claims and module updates via an input 710. The system then intakes the input data into a server device 720 and routes it through a processor module 730. The processor module 730 then determines how to assign insurance claims to the user profiles 770₁₋ₙ based on a plurality of criteria.

In one embodiment, the criteria used by the processor module 730 includes criteria derived from the load balancing rule set stored and managed in a load balance module 740. In another embodiment, the load balancing module 740 may use the outcome of the processor module 730 insurance claim assignment to update its criteria for the next insurance claim.

In one embodiment, the criteria used by the processor module 730 includes the method of checking for conditional attribute matches based on the conditional attributes created in an attribute management module 750. In order to create the conditional attributes required by the attribute management module 750 for this criteria, the processor module 730 pulls attribute data from the user profiles 770₁₋ₙ.

In one embodiment, the criterion used by the processor module 730 includes criteria derived from the Bidirectional Hierarchy Segmentation Model stored and managed in the segmentation module 760.

The processor module 730 may use a combination of the above criteria in order to produce an appropriate insurance claim assignment.

Once an insurance claim is assigned appropriately, it is sent to an output 780 for distribution to individual user workstations. The output 780 may be a device that transmits data, carries data and/or that processes data for example, prior to the data being transmitted to the users by the processor. In one embodiment, individual user workstations may also send a request to the server device 720 to check the status of his or her current caseload.

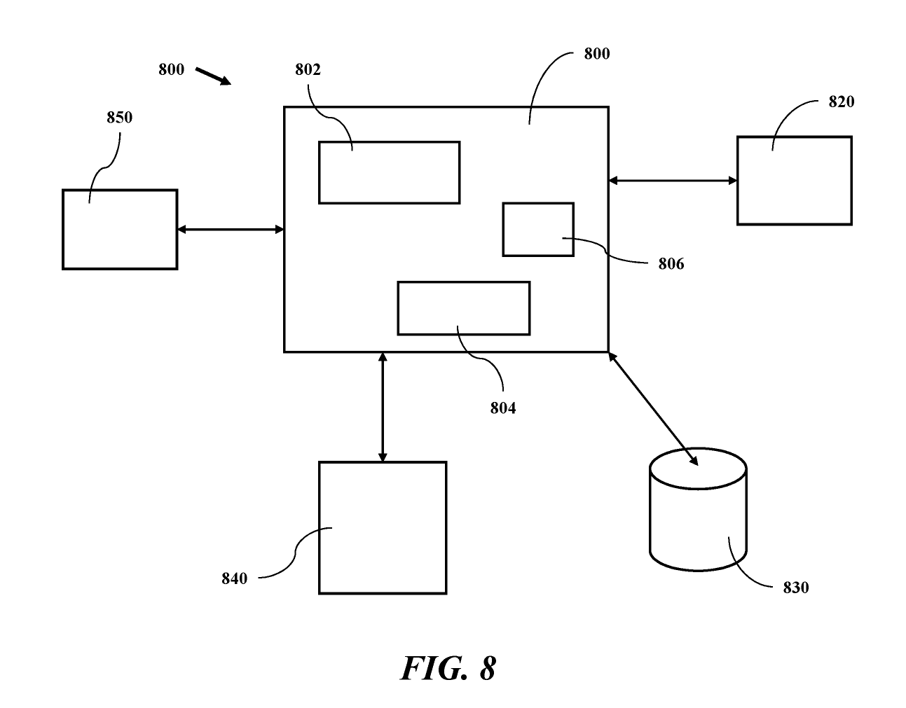

FIG. 8 discloses an example of a load balancing and/or segmentation system that includes a processor 800. The processor may be a server and may include separate modules, engines or processors 802, 804, 806 for accomplishing the various controlling functions required by the system. These processors may include for example, a load balancing module or processing engine 802, a segmentation module or processor 804, and, for example, a processor configured to configure and modify the data elements or attributes provided to the system. The system may include an input device or system 850. The input device may by a computer system or network (e.g., cloud based) that may include information regarding the task or claim (i.e., the load) being distributed to the various workers or claim handlers. For example, the input device 850 may include information related to an insurance claim. This information may be received from incoming telephone calls, emails and/or other conduits for carrying information. The input device 850 may organize, sort and/or arrange the information into a set of data or attributes for each claim or task. Data from the input device 850 may be communicated to the processor 800 via electronic files, for example.

The exemplary system shown in FIG. 8 may further include a storage device or system 830 for storing information used by the system. For example, the data storage device 830 may be accessed via a cloud based system and may be a locally storage device or reside remote from the system and processor 800. The processor 800 may communicate electronic files and data to and from the storage device 830. The system may include a control display and interface device 820. The control and display device 820 may be, for example, a personal computer, tablet or portable electronic device. Operation of the processor may be controlled and adjusted by providing commands inputted on the control device 820, which may include a display and a keyboard for example. The system may further include a worker's (e.g., a handler's) operating device 840. The operating device 840 may be, for example, a personal computer, tablet or portable electronic device. The processor 800 may communicate electronic files and data to and from the operating device 840. For example, the data or files being communicated may relate to tasks or claims being assigned to the worker of claim handler.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems, and program products on any machine-readable media for accomplishing various operations. The embodiments of the present disclosure may be implemented using existing computer processors, networks, servers or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Machine-executable instructions include, for example, instructions and data, which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A computer implemented method for load balancing using a dynamic allowed deviation, comprising the steps of:
identifying a plurality of tasks to be assigned to a plurality of workers and identifying a first set of attributes for each of the tasks;
identifying a second set of attributes for each of the plurality of workers, wherein one of the attributes in the second set of attributes is the number of tasks being handled by the worker;
computing the allowed deviation between the highest number of tasks assigned to one of the plurality of workers and the lowest number of tasks assigned to one of the plurality of workers based on the number of the plurality of tasks being assigned during a predetermined time period;
assigning each of the plurality of tasks to one of the plurality of workers based on matching at least a portion of the first set of attributes with at least a portion of the second set of attributes and wherein the assigning of the tasks is conducted so that the difference between the highest number of tasks assigned to one of the plurality of workers and the lowest number of tasks assigned to a worker does not exceed the allowed deviation.

2. The method of claim 1, further comprising the step of forming a conditional attribute in at least one of the plurality of second sets of attributes, wherein the conditional attribute includes at least two attributes in the at least one of the plurality of second sets of attributes.

3. The method of claim 2, wherein the step of assigning each of the tasks based on matching the attributes includes only matching the at least two attributes that make up the conditional attribute with attributes in the first set of attributes when all of the at least two attributes are present in the second set of attributes.

4. The method of claim 1, further comprising the step of assigning a weighted value to one of the plurality of tasks based on the first set of attributes.

5. The method of claim 4, further comprising the step of determining the number of tasks being handled by one of the plurality of workers based on the weighted value of each of the tasks being handled by the one of the plurality of workers.

6. The method of claim 5, further comprising the step of determining the weighted value of each of the tasks being handled by the one of the plurality of workers based on a complexity of the one of the tasks.

7. The method of claim 5, further comprising the step of adjusting the predetermined time period prior to computing the allowed deviation.

8. An insurance claim processing system:
a processor configured to receive a first set of attributes related to an insurance claim;
wherein the processor is configured to receive a plurality of second set attributes, wherein each of the attributes in the second set of attributes is associated with a particular claim handler;
wherein one of the attributes in the second set of attributes is the number of insurance claims being handled by the associated claim handler, and wherein the processor is configured to assign the insurance claim to one of a plurality of claim handlers so that the difference between the highest number of claims assigned to each of the plurality of claim handlers and the lowest number of claims assigned to a claim handler does not exceed an allowed deviation;
wherein the processor is configured to determine the allowed deviation based on the number of claims assigned to the claim handlers over a predetermined period of time.

9. The processing system of claim 8, wherein the processor is configured to assign a weighted value to the insurance claim based on the first set of attributes.

10. The processing system of claim 9, wherein the processor is configured to assign a weighted value to the number of insurance claims being handled by a claim handler.

11. The processing system of claim 10, wherein the weighted value of the number of insurance claims being handled by a claim handler is determined based on a complexity of one or more of the insurance claims being handled by the claim handler.

12. The processing system of claim 8, wherein the predetermined period of time is adjustable.

13. The processing system of claim 8, wherein at least one of the plurality of second sets of attributes includes a conditional attribute, and wherein the conditional attribute includes at least two attributes associated with the claim handler; and
wherein the processor is configured to designate the insurance claim as being handled by the claim handler when the attributes in the first set of attributes are matched in the second set of attributes, and wherein the processor is configured so that the at least two attributes that make up the conditional attribute are only available to be matched with the first set of attributes when all of the at least two attributes are present in the second set of attributes.

14. An insurance claim processing system:
a processor configured to receive a first set of attributes related to an insurance claim;
wherein the processor is configured to receive a plurality of second set attributes, wherein each of the attributes in the second set of attributes is associated with a particular claim handler;
wherein at least one of the plurality of second sets of attributes includes a conditional attribute, and wherein the conditional attribute includes at least two attributes associated with the claim handler;
wherein the processor is configured to designate the insurance claim as being handled by the claim handler when the attributes in the first set of attributes are matched in the second set of attributes, and wherein the processor is configured so that the at least two attributes that make up the conditional attribute are only available to be matched with the first set of attributes when all of the at least two attributes are present in the second set of attributes.

15. The claim processing system of claim 14, wherein the processor is configured to perform a load balancing function by balancing the distribution of insurance claims to a plurality of claim handlers.

16. The claim processing system of claim 15, wherein the processor is configured to assign incoming insurance claims to claim handlers so that the difference between the highest number of claims assigned to a claim handler and the lowest number of claims assigned to a claim handler does not exceed an allowed deviation.

17. The claim processing system of claim 16, wherein the processor is configured to determine the allowed deviation based on the number of claims assigned to the claim handlers over a predetermined period of time.

18. The processing system of claim 17, wherein the processor is configured to assign a weighted value to the insurance claim based on the first set of attributes.

19. The processing system of claim 17, wherein the processor is configured to assign a weighted value to the number of insurance claims being handled by a claim handler.

20. The processing system of claim 19, wherein the weighted value of the number of insurance claims being handled by a claim handler is determined based on a complexity of one or more of the insurance claims being handled by the claim handler.
